(19) United States
(12) Patent Application Publication
(10) Pub. No.: US 2010/0077743 A1
(43) Pub. Date: Apr. 1, 2010

(54) FLUID COUPLING AND STARTING DEVICE

(75) Inventors: Yoshihide Mori, Anjo-shi (JP); Keizo Araki, Hekinan-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO., LTD., Anjo-shi (JP)

(21) Appl. No.: 12/558,643

(22) Filed: Sep. 14, 2009

(30) Foreign Application Priority Data
Sep. 30, 2008 (JP) 2008-253022

(51) Int. Cl. F16H 41/04

(52) U.S. Cl. 60/364; 60/330

(57) ABSTRACT

A fluid coupling including a pump impeller rotatable about a rotation axis and having several pump blades, and a turbine runner disposed downstream of the pump impeller and including several turbine blades arranged about the rotation axis. When the pump impeller rotates, a fluid circulates between the pump impeller and the turbine runner such that the turbine runner rotates about the rotation axis. Each of the turbine blades includes an intermediate part, an outer part and an inner part, and in at least one of the turbine blades, the outer part is formed so as to be positioned on the downstream side of the intermediate part in the rotation direction.

### INCORPORATION BY REFERENCE

The disclosure of Japanese Patent Application No. 2008-253022 filed on Sep. 30, 2008 including the specification, drawings and abstract is incorporated herein by reference in its entirety.

### BACKGROUND OF THE INVENTION

The present invention relates to a fluid coupling for transmitting torque from an upstream side to a downstream side of a torque transmission path, and a starting device provided with the fluid coupling.

### DESCRIPTION OF THE RELATED ART

Generally, a fluid coupling includes a pump impeller to which torque is transmitted from a driving source and a turbine runner that is disposed facing the pump impeller. Fluid is present between the pump impeller and the turbine runner. When the pump impeller rotates due to the transmission of torque from the driving source, fluid circulates between the pump impeller and the turbine runner so that the turbine runner rotates. Fluid couplings of such type that transmit torque from an upstream side to a downstream side of a torque transmission path have been used in ships and vehicles.

For example, Japanese Patent Application Publication No. JP-A-2000-283188 discloses a starting device for a vehicle that includes a fluid coupling. This starting device includes a housing constituted by a front cover and a pump cover. The front cover is connected to an output shaft of an engine serving as a driving source and has a generally cylindrical shape with a bottom, with the pump cover connected to the front cover. The fluid coupling is provided inside the housing.

That is, the pump impeller of the fluid coupling is supported by the pump cover while a turbine runner is connected, via a connection member, to a portion of an input shaft of a speed change mechanism that is located in the housing. In such a fluid coupling, the pump impeller includes a plurality of pump blades radially extending from the input shaft, and the pump blades are arranged at regular intervals along a circumferential direction about the input shaft. The turbine runner includes a ring-shaped turbine shell connected to the connection member and a plurality of turbine blades fixed to the turbine shell and radially extending from the input shaft. The turbine blades are arranged at regular intervals along the circumferential direction.

When the housing rotates due to the transmission of torque from the engine, the pump impeller rotates in a predetermined rotation direction about the input shaft of the speed change mechanism. Accordingly, hydraulic oil circulates between the pump impeller and the turbine runner. Specifically, the hydraulic oil flows from pump impeller outlets that are positioned on the outer side in the radial direction of the pump blades toward turbine runner inlets that are positioned on the outer side in the radial direction of the turbine blades. The hydraulic oil flows inside respective spaces between two turbine blades that are adjacent to each other in the circumferential direction, from the outer side to the inner side in the radial direction. At this time, a pushing force in the rotation direction generated by the hydraulic oil circulating from the pump impeller side is applied to respective side surfaces on the upstream side in the rotation direction of the turbine blades. The hydraulic oil that applies a pushing force to the turbine blades flows from turbine runner outlets that are positioned on the inner side in the radial direction of the turbine blades toward pump impeller inlets that are positioned on the inner side in the radial direction of the pump blades. Then, the hydraulic oil flows inside spaces between two pump blades that are adjacent to each other in the circumferential direction, from the inner side to the outer side in the radial direction. Thus, the turbine runner rotates in the same rotation direction as the pump impeller, due to the transmission of torque from the pump impeller via the circulating hydraulic oil. In other words, the input shaft of the speed change mechanism is rotated by transmitting the rotation of the pump impeller to the turbine runner via the hydraulic oil.

It is preferable that a capacity coefficient of the fluid coupling (a coefficient obtained by dividing the torque transmitted to the pump impeller by the square of the rotation speed of the input shaft) does not vary significantly in accordance with a speed ratio between the pump impeller and the turbine runner, for the reduction of shift shock during slip shifting and for traveling during a failure when the clutches are disengaged. For example, in a torque converter that is typically provided in automatic transmissions, a stator is provided between the pump impeller and the turbine runner. Therefore, in a low speed ratio region where the speed ratio between the pump impeller and the turbine runner is low, the capacity coefficient of the torque converter is smaller than that of the fluid coupling described in Japanese Patent Application Publication No. JP-A-2000-283188.

However, in the fluid coupling described in Japanese Patent Application Publication No. JP-A-2000-283188, a capacity coefficient C increases as a speed ratio Sr, which is a ratio of the rotation speed of the turbine runner with respect to the rotation speed of the pump impeller, decreases, as shown in FIG. 10. That is, the capacity coefficient C is largest during idling of the vehicle (i.e., when the pump impeller rotates while the turbine runner is stationary).

The following two solutions are conceivable techniques for resolving such a problem. A first solution is to provide between the pump impeller and the turbine runner a ring-shaped baffle plate whose axial center coincides with the input shaft. With this configuration, when the flow rate of the hydraulic oil circulating between the pump impeller and the turbine runner increases while the vehicle is stopped (also referred to as “when the vehicle stalls”), the baffle plate generates a large resistance against the flow of hydraulic oil. This suppresses an increase in the capacity coefficient C when the vehicle stalls.

A second solution is to provide in the turbine runner a reservoir chamber that can temporarily hold the hydraulic oil at a position opposite to the pump impeller. With this configuration, the amount of hydraulic oil present between the pump impeller and the turbine runner in the housing is adjusted in accordance with an increase/decrease in the torque from the engine. As a result, the increase in the capacity coefficient C when the vehicle stalls is suppressed.

However, in the above two solutions, it is necessary to provide the baffle plate or the reservoir chamber in addition to the pump impeller and the turbine runner, leading to an increase in the size of the fluid coupling. This results in an increase in the size of the starting device provided with the fluid coupling.

### SUMMARY OF THE INVENTION

It is an object of the present invention to provide a fluid coupling and a starting device that can reduce variation in a capacity coefficient in accordance with a speed ratio between a pump impeller and a turbine runner, while suppressing an increase in the sizes thereof.

In order to achieve the above object, a fluid coupling according to the present invention includes: a pump impeller that is disposed on a torque transmission path, rotatable about a predetermined rotation axis, and includes a plurality of pump blades arranged along a circumferential direction about the rotation axis; and a turbine runner that is disposed on a downstream side of the pump impeller in the torque transmission path, and includes a plurality of turbine blades arranged along the circumferential direction about the rotation axis. When the pump impeller rotates in a predetermined rotation direction due to transmitted torque, a fluid circulates between the pump impeller and the turbine runner, such that the turbine runner rotates in the rotation direction about the rotation axis. The turbine blades each include, with respect to a radial direction about the rotation axis, an intermediate part, an outer part that is positioned farther outward than the intermediate part, and an inner part that is positioned farther inward than the intermediate part. In at least one of the plurality of turbine blades, the outer part is formed so as to be positioned on the downstream side of the intermediate part in the rotation direction.

With the above configuration, the fluid flowing from the pump impeller side to the turbine runner side based on the rotation of the pump impeller flows into respective spaces between two radial outer parts of the turbine blades that are adjacent to each other in the circumferential direction. At that time, the fluid applies a pushing force in the rotation direction to the turbine blades that are positioned on the downstream side in the rotation direction of the pump blades that pushed out the fluid to the turbine runner side. As a result, the turbine runner rotates about the rotation axis. Here, in at least one of the turbine blades, the outer part is formed so as to be positioned on the downstream side of the intermediate part. Turbine runner inlets provided at positions that correspond to the outer parts having such shapes hinder the fluid from smoothly flowing in respective spaces between two turbine runner inlets that are adjacent to each other in the circumferential direction. That is, turbulence occurs in the circulation of the fluid in the respective spaces between two turbine runner inlets that are adjacent to each other in the circumferential direction. Convection generated due to such turbulence in the fluid circulation interferes with turning of the turbine blades, leading to a reduction in a capacity coefficient. Moreover, as the speed ratio of the turbine runner with respect to the pump impeller decreases, the convection of the fluid circulation in the respective spaces between two turbine runner inlets that are adjacent to each other in the circumferential direction becomes larger, and therefore, the reduction in the capacity coefficient becomes more remarkable. Therefore, it is possible to suppress increases in the size and variation of the capacity coefficient in accordance with the speed ratio between the pump impeller and the turbine runner.

In the fluid coupling according to the present invention, in at least one of the plurality of turbine blades, the inner part is formed so as to be positioned on an upstream side of the intermediate part in the rotation direction.

In this configuration, turbine runner outlets provided at positions that correspond to the inner parts of the turbine blades having such shapes enable the fluid to smoothly flow out from respective spaces between two turbine runner outlets that are adjacent to each other in the circumferential direction to the pump impeller side. That is, the circulation efficiency of the fluid increases between the pump impeller and the turbine runner. Therefore, the pushing force applied by the fluid circulating based on the rotation of the pump impeller to the side surfaces of the turbine blades on the upstream side in the rotation direction is larger, compared to a fluid coupling that uses conventional turbine blades each having its radial inner part and radial outer part located in the same position in the rotation direction. In other words, the torque transmission efficiency from the pump impeller to the turbine runner increases overall regardless of the speed ratio of the turbine runner with respect to the pump impeller. Therefore, it is possible to increase the capacity coefficient overall regardless of the speed ratio of the turbine runner with respect to the pump impeller.

In the fluid coupling according to the present invention, the pump blades each include an intermediate part and an outer part that is positioned farther outward than the intermediate part with respect to the radial direction about the rotation axis, and in at least one of the plurality of pump blades, the outer part is formed so as to be positioned on the downstream side of the intermediate part in the rotation direction.

In this configuration, pump impeller outlets provided at positions that correspond to outer parts of the pump blades having such shapes enable the fluid to smoothly flow out from respective spaces between two pump impeller outlets that are adjacent to each other in the circumferential direction to the turbine runner side. That is, the circulation efficiency of the fluid increases between the pump impeller and the turbine runner. Therefore, the torque transmission efficiency from the pump impeller to the turbine runner increases overall in accordance with the increase in the circulation efficiency of the fluid between the pump impeller and the turbine runner. Thus, it is possible to increase the capacity coefficient overall regardless of the speed ratio of the turbine runner with respect to the pump impeller.

In the fluid coupling according to the present invention, the pump blades each include an intermediate part and an inner part that is positioned farther inward than the intermediate part with respect to the radial direction about the rotation axis, and in at least one of the plurality of pump blades, the inner part is formed so as to be positioned on the downstream side of the intermediate part in the rotation direction.

In this configuration, pump impeller inlets provided at positions that correspond to inner parts of the pump blades having such shapes enable the fluid to smoothly flow from the turbine runner side into respective spaces between two pump impeller inlets that are adjacent to each other in the circumferential direction. That is, the circulation efficiency of the fluid increases between the pump impeller and the turbine runner. Therefore, the torque transmission efficiency from the pump impeller to the turbine runner increases overall in accordance with the increase in the circulation efficiency of the fluid between the pump impeller and the turbine runner. Thus, it is possible to increase the capacity coefficient overall regardless of the speed ratio of the turbine runner with respect to the pump impeller.

According to an aspect of the present invention, a starting device for transmitting torque from a driving source to an input member of a speed change mechanism is provided. The starting device includes a housing to which the torque from the driving source is transmitted, and which is filled with a fluid, as well as the fluid coupling described above. The fluid coupling is disposed in the housing. The pump impeller is fixed to the housing and the turbine runner is connected to the input member of the speed change mechanism.

With this configuration, variation in the capacity coefficient in accordance with changes in the speed ratio of the turbine runner with respect to the pump impeller is suppressed. Therefore, variation in the efficiency of torque transmission from the engine side to the speed change mechanism side based on a traveling state of the vehicle is suppressed.

### BRIEF DESCRIPTION OF THE DRAWINGS

FIG. 1 is a cross-sectional side view showing a part of a starting device according to an embodiment of the present invention;

FIG. 2A is a perspective view of a pump impeller, and FIG. 2B is a perspective view of a pump blade;

FIG. 3A is a perspective view of a turbine runner, and FIG. 3B is a perspective view of a turbine blade;

FIG. 4 is a perspective view showing both the pump blade and the turbine blade;

FIG. 5 is a schematic plan view of the blades as seen from an arrow A direction in FIG. 4;

FIG. 6 is a schematic plan view of the blades as seen from an arrow B direction in FIG. 4;

FIGS. 7A, 7B, 7C, and 7D are operation diagrams showing the flow of hydraulic oil when a fluid coupling is operated;

FIG. 8 is a graph showing a relationship between a speed ratio and a capacity coefficient;

FIG. 9 is a graph showing a relationship between the degree of a third bending angle and variation in the capacity coefficient; and

FIG. 10 is a graph showing a relationship between a speed ratio and a capacity coefficient in a conventional fluid coupling.

### DETAILED DESCRIPTION OF THE EMBODIMENTS

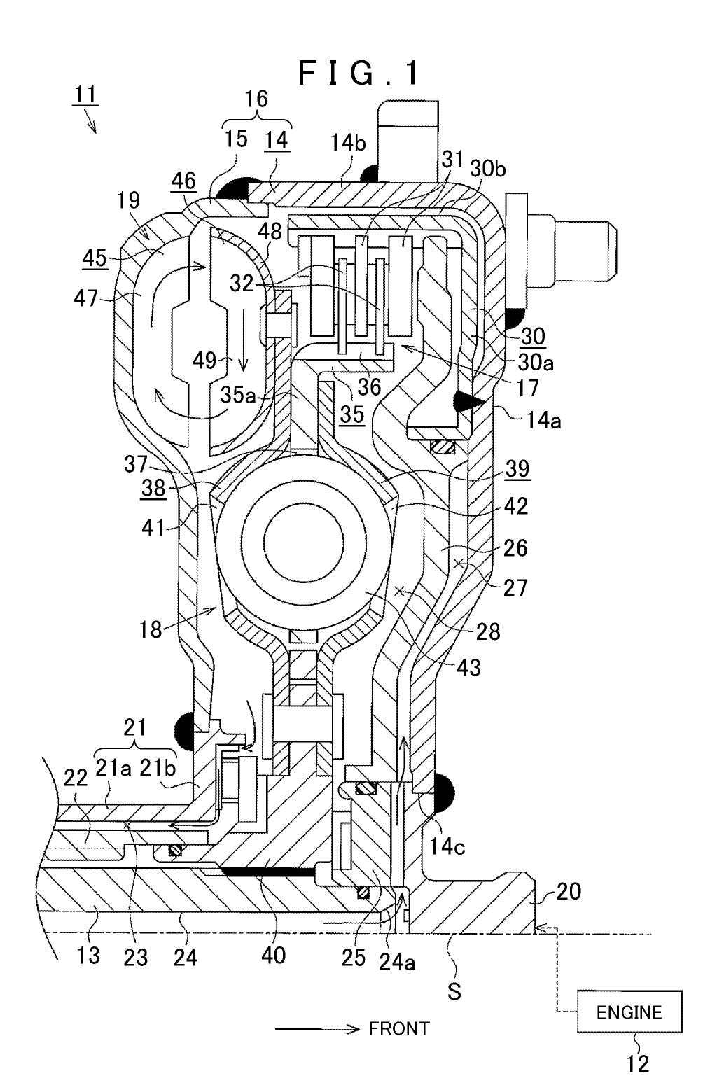

An embodiment that realizes the present invention as a starting device provided in a vehicle will be described with reference to FIGS. 1 to 9. Note that in the description below in the specification, a front side represents a right side in FIG. 1 and a rear side represents a left side in FIG. 1.

As shown in FIG. 1, a starting device 11 according to the present embodiment is a device for transmitting torque generated by an engine 12, which serves as a driving source and is positioned on an upstream side of a torque transmission path; to an input shaft (input member) 13 of a speed change mechanism (not shown) that is positioned on a downstream side of the torque transmission path. Specifically, the starting device 11 includes a housing 16 constituted by a front cover 14 and a pump cover 15. The front cover 14 is connected to an output side of the engine 12 and has a generally cylindrical shape with a bottom, and the pump cover 15 is fixed by welding to an end portion on an outer circumferential side of the front cover 14. The housing 16 is filled with circulating hydraulic oil. Accommodated in the housing 16 are a clutch mechanism 17 that operates clutches to directly transmit the torque from the engine 12 to the input shaft 13 of the speed change mechanism, a damper device 18 that can absorb a vibration component included in the torque transmitted via the clutch mechanism 17, and a fluid coupling 19 that transmits the torque using the hydraulic oil in the housing 16.

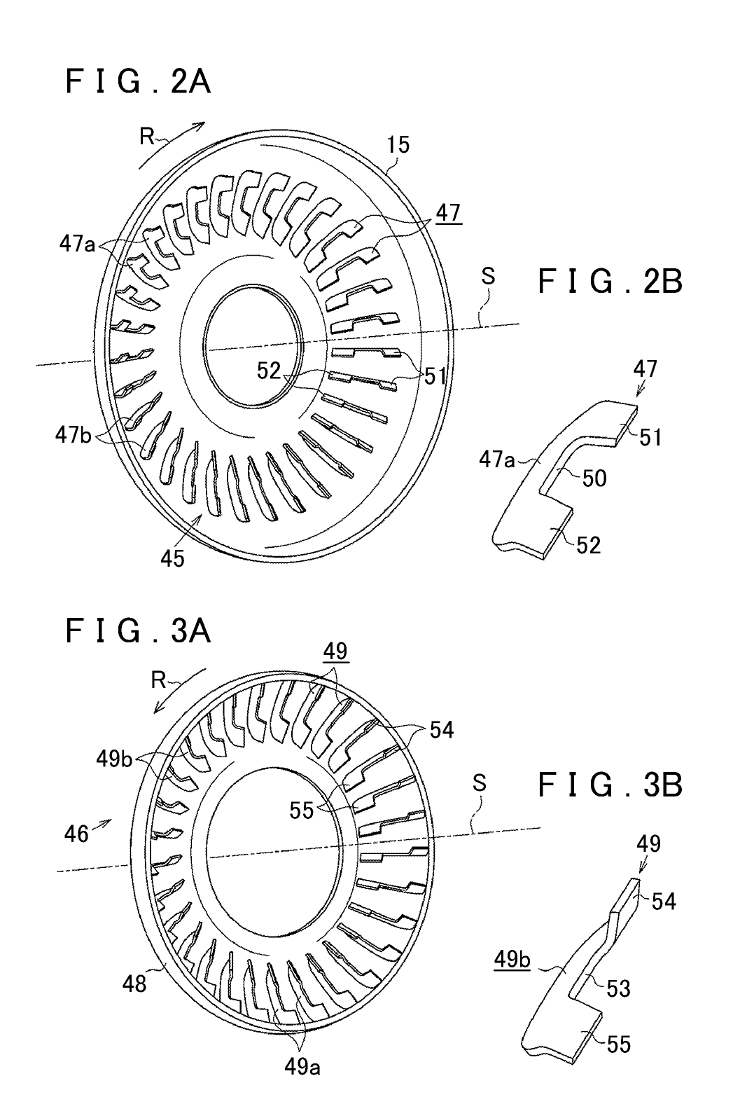

The front cover 14 is integrally formed from a bottom portion 14a having a disc shape from a planar view, and a cylindrical portion 14b. The cylindrical portion 14b is formed centered on a predetermined rotation axis S (indicated by a dashed line in FIG. 1) that passes through a radial center of the bottom portion 14a in the front-rear direction. An opening 14c is formed at a radial center of the bottom portion 14a of the front cover 14, and is closed with a centerpiece 20. When the torque is transmitted from the engine 12, the front cover 14 rotates in a predetermined rotation direction R (see FIG. 2A) about the rotation axis S. Note that the predetermined rotation direction R is a direction in which the front cover 14 rotates based on the torque from the engine 12.

The pump cover 15 has a general ring shape that can close a rear side opening of the cylindrical portion 14b of the front cover 14. A pump-driving shaft 21 for transmitting a driving force to an oil pump of a transmission (not shown) is fixed to a central portion of the pump cover 15. The pump-driving shaft 21 includes a cylinder portion 21a extending along the front-rear direction and a flange portion 21b provided at a front end of the cylinder portion 21a. A rear end of the cylinder portion 21a is connected to the oil pump while an outer edge of the flange portion 21b is bonded to the pump cover 15. An intermediate part of the input shaft 13 of the speed change mechanism is positioned inside the cylinder portion 21a of the pump-driving shaft 21.

A sleeve 22 having a cylindrical shape and extending in the front-rear direction is provided between an inner circumferential surface of the cylinder portion 21a of the pump-driving shaft 21 and an outer circumferential surface of the input shaft 13. The sleeve 22 is configured such that a front end thereof is positioned substantially at the same position in the front-rear direction as a front end of the pump-driving shaft 21 and a rear end thereof is positioned inside the speed change mechanism. Part of the hydraulic oil circulating in the housing 16 flows out of the housing 16 (i.e., to the oil pump side) through a circulating flow path 23 formed between an outer circumferential surface of the sleeve 22 and the inner circumferential surface of the cylinder portion 21a of the pump-driving shaft 21.

A supply flow path 24 is formed in the input shaft 13 of the speed change mechanism, extending in the front-rear direction. The supply flow path 24 opens at the front end portion of the input shaft 13. The hydraulic oil flowing forward in the supply flow path 24 flows out from an outflow opening 24a formed at the front end portion of the input shaft 13 into the housing 16.

The input shaft 13 of the speed change mechanism supports at the front end thereof a piston 26 via a support member 25, and the piston is freely movable in the front-rear direction. The piston 26 has a ring shape from a planar view and is disposed facing the bottom portion 14a of the front cover 14. The piston 26 moves in the front-rear direction in accordance with a pressure difference between the hydraulic oil in a first space 27, which is formed between the piston 26 and the bottom portion 14a of the front cover 14, and the hydraulic oil in a second space 28 formed on the rear side of the piston 26. Note that the hydraulic oil supplied from the supply flow path 24 to the housing 16 flows into the first space 27.

Next, the clutch mechanism 17 will be described.

The clutch mechanism 17 includes a clutch drum 30 that is connected to the bottom portion 14a of the front cover 14 and has a generally cylindrical shape. The clutch drum 30 includes a fixed portion 30a that is fixed to the bottom portion 14a of the front cover 14 and has a ring shape; and a support portion 30b that is positioned on the outer side of the piston 26 in the radial direction centered on the rotation axis S and has a generally cylindrical shape.

A plurality of (three in the present embodiment) first clutch plates 31 arranged along the front-rear direction is supported on the inner circumferential side of the support portion 30b of the clutch drum 30 so as to be movable in the front-rear direction. Second clutch plates 32 are respectively provided between two first clutch plates 31 that are adjacent to each other in the front-rear direction. The second clutch plates 32 are supported by a drive plate 35 of the damper device 18 (described later) so as to be movable in the front-rear direction. Thus, when the piston 26 moves rearward, the first clutch plates 31 and the second clutch plates 32 that are adjacent to each other in the front-rear direction are engaged, thereby enabling the transmission of torque from the engine 12 to the damper device 18 (i.e., the speed change mechanism side) via the clutch mechanism 17. On the other hand, when the piston 26 moves forward, the first clutch plates 31 and the second clutch plates 32 that are adjacent to each other in the front-rear direction are disengaged, thereby regulating the torque transmission via the clutch mechanism 17.

Next, the damper device 18 will be described.

The damper device 18 is provided with the drive plate 35 including a plate main body 35a that has a general ring shape. The drive plate 35 includes a support 36 protruding forward from the outer side in the radial direction of the plate main body 35a. The second clutch plates 32 are supported by the support 36 so as to be movable in the front-rear direction. The drive plate 35 includes a plurality of first torque transmission portions 37 (only one of which is shown in FIG. 1) protruding radially inward from the plate main body 35a. The first torque transmission portions 37 are arranged at regular intervals in the circumferential direction about the rotation axis S.

In the damper device 18, a first driven plate 38 and a second driven plate 39 that have general ring shapes are provided on both sides in the front-rear direction of the plate main body 35a of the drive plate 35. The driven plates 38, 39 are both connected to the input shaft 13 via a turbine hub 40. The driven plates 38, 39 each have a plurality of second torque transmission portions 41, 42 (of which only one each is shown in FIG. 1). The second torque transmission portions 41, 42 are disposed at positions identical to those of the first torque transmission portions 37 in the radial direction about the rotation axis S.

Moreover, in the damper device 18, damper springs 43 are provided at positions between two first torque transmission portions 37 that are adjacent to each other in the circumferential direction and between the second torque transmission portions 41, 42. The torque transmitted to the damper device 18 via the clutch mechanism 17 is transmitted to the input shaft 13 of the speed change mechanism via the drive plate 35 (the first torque transmission portions 37), the damper springs 43, the driven plates 38, 39 (the second torque transmission portions 41, 42), and the turbine hub 40. Note that the damper device 18 may have a configuration provided with an intermediate member including third torque transmission portions that are disposed in the circumferential direction between the first torque transmission portion 37 and the second torque transmission portions 41, 42; and provided with damper springs 43 each disposed between two torque transmission portions that are adjacent to each other in the circumferential direction.

Next, the fluid coupling 19 will be described with reference to FIGS. 1 to 3.

The fluid coupling 19 includes a pump impeller 45 that is fixed to the pump cover 15, and a turbine runner 46 that is disposed facing the pump impeller 45 and connected to the input shaft 13 of the speed change mechanism. The pump impeller 45 is provided with a plurality of (31 in the present embodiment) pump blades 47 that is fixed to the pump cover 15, as shown in FIGS. 2A and 2B. The pump blades 47 are arranged at regular intervals in the circumferential direction about the rotation axis S. Two pump blades 47 that are adjacent to each other in the circumferential direction are disposed such that side surfaces thereof face each other. The pump blades 47 each include a first side surface 47a that is positioned on the upstream side in the rotation direction R, and a second side surface 47b that is positioned on the downstream side in the rotation direction R. In other words, the pump blades 47 each include the first side surface 47a at the rear side in the rotation direction R, and the second side surface 47b at the front side in the rotation direction R.

The turbine runner 46 is provided with a turbine shell 48, which is fixed to the turbine hub 40 via the first driven plate 38 of the damper device 18 and has a general ring shape; and a plurality of (29 in the present embodiment) turbine blades 49 that is fixed to the turbine shell 48, as shown in FIGS. 1, 3A, and 3B. The turbine blades 49 are disposed at regular intervals in the circumferential direction about the rotation axis S. Two turbine blades 49 that are adjacent to each other in the circumferential direction are each disposed such that side surfaces thereof face one another. The turbine blades 49 each include a first side surface 49a that is positioned on the upstream side in the rotation direction R, and a second side surface 49b that is positioned on the downstream side in the rotation direction R. In other words, the turbine blades 49 each include the first side surface 49a at the rear side in the rotation direction R, and the second side surface 49b at the front side in the rotation direction R.

When the housing 16 rotates in the rotation direction R based on the torque from the engine 12, the hydraulic oil between the pump impeller 45 and the turbine runner 46 circulates, thereby transmitting the rotation of the pump impeller 45 to the turbine runner 46 via the hydraulic oil. Thus, in the present embodiment, even when the clutch mechanism 17 is not operated, the torque from the engine 12 is transmitted to the input shaft 13 of the speed change mechanism by driving the fluid coupling 19.

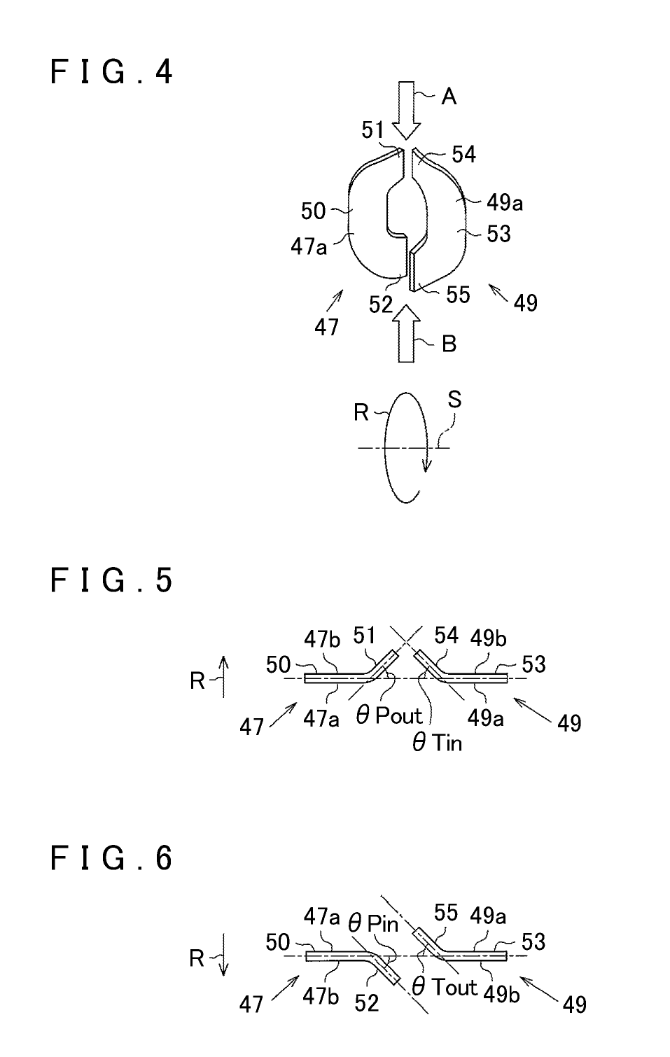

Next, the blades 47, 49 will be described with reference to FIGS. 2 to 6. Note that FIG. 5 is a schematic plan view of the blades 47, 49 as seen from an arrow A direction shown in FIG. 4. FIG. 6 is a schematic plan view of the blades 47, 49 as seen from an arrow B direction shown in FIG. 4. In addition, to facilitate understanding of the description, a second turbine side protrusion 55 (described later) is not shown in FIG. 5, and a first turbine side protrusion 54 (described later) is not shown in FIG. 6.

The pump blade 47 is made from a metal plate and formed to have a general U shape in the side view, as shown in FIGS. 2A, 2B, and 4. Specifically, the pump blade 47 includes a blade main body 50 extending in the radial direction from the rotation axis S, a first pump side protrusion 51 protruding forward from a radial outer portion of the blade main body 50, and a second pump side protrusion 52 protruding forward from a radial inner portion of the blade main body 50.

As shown in FIGS. 4 and 5, the first pump side protrusion 51 is formed by bending such that a distal end thereof is positioned on the downstream side (namely, on the front side) of a base end thereof in the rotation direction R. Specifically, the first pump side protrusion 51 is bent toward the rotation direction R such that a first bending angle θPout relative to the blade main body 50 is a predetermined angle ranging from 0° to 90° (for example, 45°). That is, in the present embodiment, an outer part that is positioned radially outside a radial intermediate part of the pump blade 47 is formed such that the distal end thereof is positioned on the downstream side of the base end thereof in the rotation direction R. In other words, in the pump blade 47, the outer part thereof is formed so as to be positioned on the downstream side of the intermediate part in the rotation direction R. A pump impeller outlet is formed at a position corresponding to the outer part of the pump blade 47.

As shown in FIGS. 4 and 6, the second pump side protrusion 52 is formed by bending such that a distal end thereof is positioned on the downstream side (namely, on the front side) of a base end thereof in the rotation direction R. Specifically, the second pump side protrusion 52 is bent toward the rotation direction R such that a second bending angle θPin relative to the blade main body 50 is a predetermined angle ranging from 0° to 90° (for example, 45°). That is, in the present embodiment, an inner part that is positioned radially inside the radial intermediate part of the pump blade 47 is formed such that the distal end thereof is positioned on the downstream side of the base end thereof in the rotation direction R. In other words, in the pump blade 47, the inner part thereof is formed so as to be positioned on the downstream side of the intermediate part in the rotation direction R. A pump impeller inlet is formed at a position corresponding to the inner part of the pump blade 47.

The turbine blade 49 is made from a metal plate and formed to have a general U shape in the side view, as shown in FIGS. 3A, 3B, and 4. Specifically, the turbine blade 49 includes a blade main body 53 extending in the radial direction from the rotation axis S, the first turbine side protrusion 54 protruding rearward from a radial outer portion of the blade main body 53, and a second turbine side protrusion 55 protruding rearward from a radial inner portion of the blade main body 50.

As shown in FIGS. 4 and 5, the first turbine side protrusion 54 is formed by bending such that a distal end thereof is positioned on the downstream side (namely, on the front side) of a base end thereof in the rotation direction R. Specifically, the first turbine side protrusion 54 is bent toward the rotation direction R such that a third bending angle θTin relative to the blade main body 53 is a predetermined angle ranging from 0° to 90° (for example, 50°). That is, in the present embodiment, an outer part that is positioned radially outside a radial intermediate part of the turbine blade 49 is formed such that the distal end thereof is positioned on the downstream side of the base end thereof in the rotation direction R. In other words, in the turbine blade 49, the outer part thereof is formed so as to be positioned on the downstream side of the intermediate part in the rotation direction R. A turbine runner inlet is formed at a position corresponding to the outer part of the turbine blade 49.

As shown in FIGS. 4 and 6, the second turbine side protrusion 55 is formed by bending such that a distal end thereof is positioned on the upstream side (namely, on the rear side) of a base end thereof in the rotation direction R. Specifically, the second turbine side protrusion 55 is bent toward the opposite direction to the rotation direction R such that a fourth bending angle θTout relative to the blade main body 53 is a predetermined angle ranging from 0° to 90° (for example, 45°). That is, in the present embodiment, an inner part that is positioned radially inside the radial intermediate part of the turbine blade 49 is formed such that the distal end thereof is positioned on the upstream side of the base end in the rotation direction R. In other words, in the turbine blade 49, the inner part thereof is formed so as to be positioned on the upstream side of the intermediate part in the rotation direction R. A turbine runner outlet is formed at a position corresponding to the inner part of the turbine blade 49.

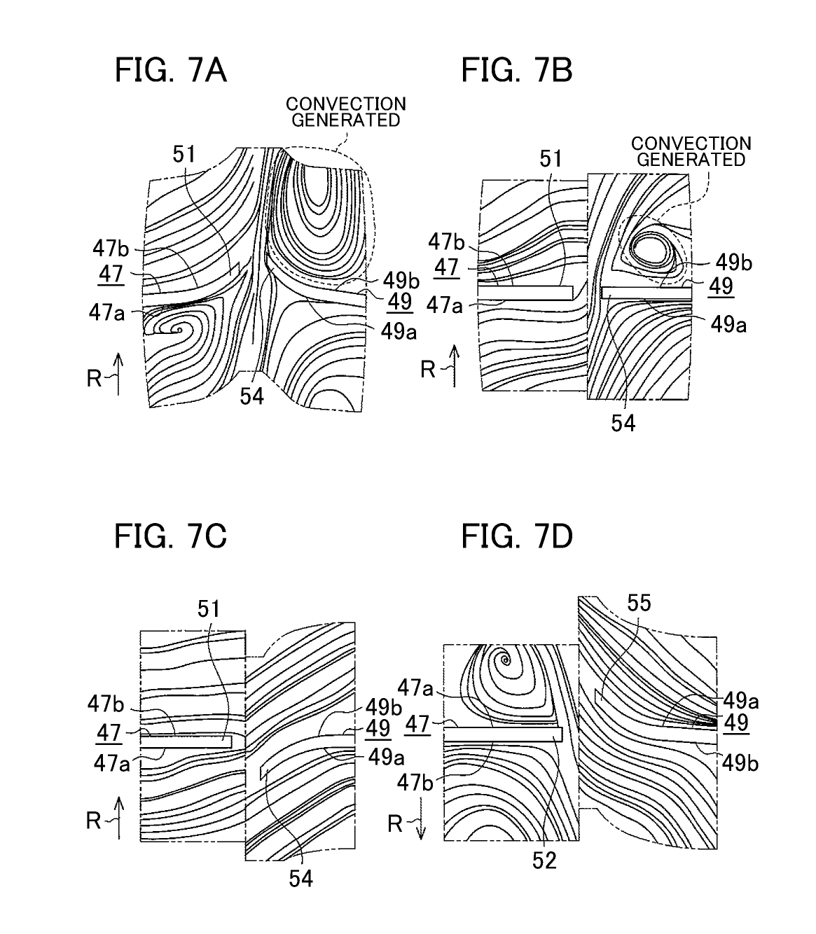

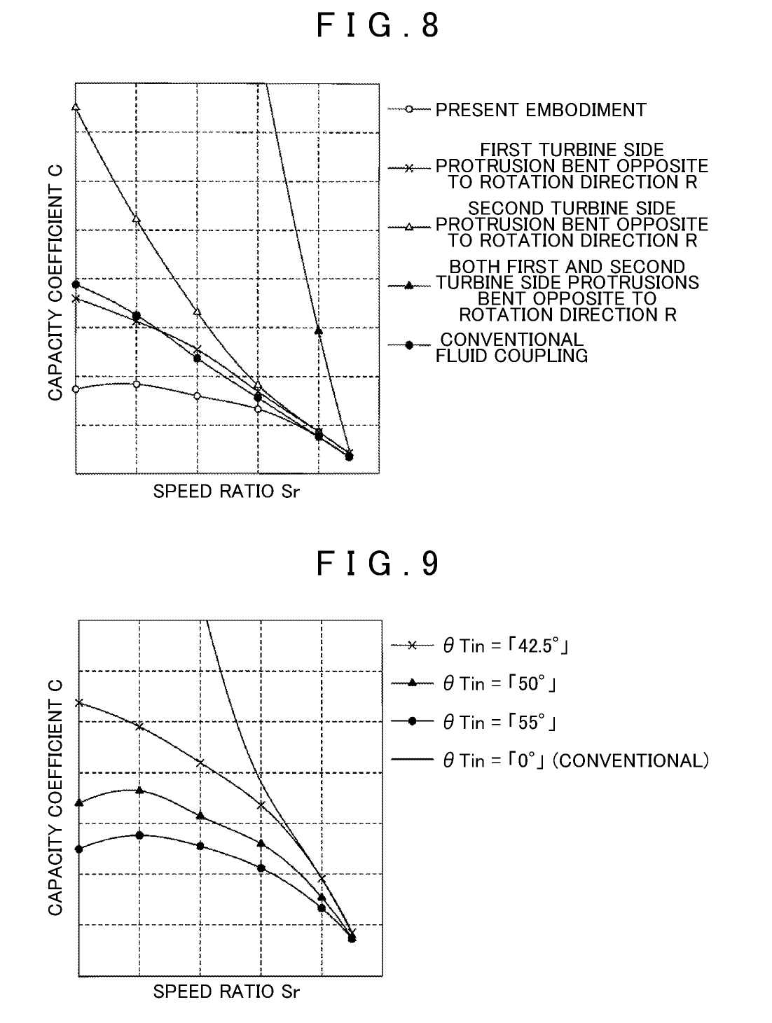

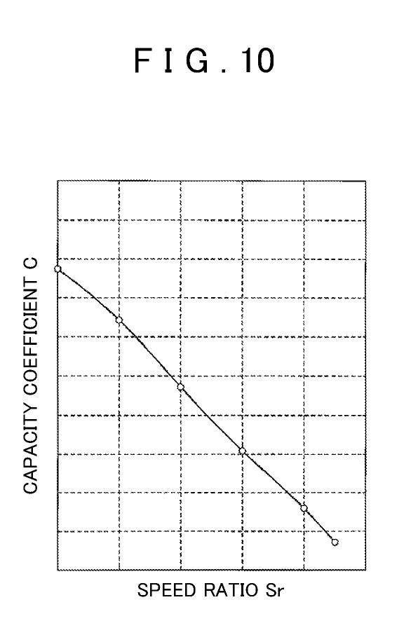

Next, an operation when the torque from the engine 12 is transmitted to the input shaft 13 of the speed change mechanism based on the driving force of the fluid coupling 19 will be described with reference to FIGS. 7 and 8. Note that it is assumed the clutch mechanism 17 is not operated here.

When the housing 16 starts rotating in the rotation direction R based on the torque from the engine 12, the pump impeller 45 of the fluid coupling 19 fixed to the housing 16 also starts rotating in the rotation direction R. That is, the pump blades 47 start turning around the rotation axis S. Then, the hydraulic oil present in the space between two pump blades 47 that are adjacent to each other in the circumferential direction flows from the second pump side protrusion 52 side to the first pump side protrusion 51 side, such that the hydraulic oil is pushed out from the second side surface 47b of the pump blade 47 that is on the upstream side in the rotation direction R. From between two first pump side protrusions 51 that are adjacent to each other in the circumferential direction, the hydraulic oil is pushed out to the turbine runner 46 side due to the turning of the pump blades 47.

The first pump side protrusion 51 of the present embodiment is shaped by bending such that the distal end thereof points in the rotation direction R. Therefore, compared to a conventional unbent turbine blade, the first pump side protrusion 51 can more easily guide the hydraulic oil toward the first turbine side protrusion 54 side of the turbine blade 49 that is positioned on the downstream side in the rotation direction R. As a result, as shown in FIG. 7A, the hydraulic oil present between two pump blades 47 that are adjacent to each other in the circumferential direction is suitably pushed out in the upper right direction in FIGS. 5 and 7A by the first pump side protrusion 51 positioned on the upstream side in the rotation direction R.

The hydraulic oil pushed out by the first pump side protrusion 51 applies a pushing force in the rotation direction R to the first turbine side protrusion 54 of the turbine blade 49, which is positioned on the downstream side in the rotation direction R of the first pump side protrusion 51 that pushed out the hydraulic oil. At the same time, the hydraulic oil flows into the space between two first turbine side protrusions 54 that are adjacent to each other in the circumferential direction. As a result, the turbine blades 49 turn around the rotation axis S, that is, the turbine runner 46 rotates in the rotation direction R.

Here, in the conventional fluid coupling in which the first turbine side protrusions 54 are not bent, convection interfering with the turning of the first turbine side protrusion 54 is very small at the downstream side in the rotation direction R of the first turbine side protrusion 54, as shown in FIG. 7B. Therefore, as shown in FIG. 8, as a speed ratio Sr of the rotation speed of the turbine runner 46 with respect to the rotation speed of the pump impeller 45 decreases, a capacity coefficient C increases. When the first turbine side protrusion 54 is bent such that the distal end thereof points to a direction opposite the rotation direction R, contrary to the present embodiment, the hydraulic oil easily flows into the space between two first turbine side protrusions 54 that are adjacent to each other in the circumferential direction, as shown in FIG. 7C. That is, convection interfering with the turning of the first turbine side protrusion 54 is not generated at the downstream side in the rotation direction R of the first turbine side protrusion 54. Therefore, as shown in FIG. 8, there is more variation in the capacity coefficient C in accordance with changes in the speed ratio Sr described above, compared to the conventional fluid coupling.

In this regard, the first turbine side protrusion 54 of the present embodiment is shaped by bending such that the distal end thereof points in the rotation direction R. That is, the first turbine side protrusion 54 has a shape for more strongly interfering with the flow of the hydraulic oil from the first pump side protrusion 51 side, compared to the conventional unbent turbine blade. Therefore, a smooth flow of hydraulic oil can be effectively interfered with between two first turbine side protrusions 54 that are adjacent to each other in the circumferential direction. In other words, large convection of the hydraulic oil is generated between two first turbine side protrusions 54 that are adjacent to each other in the circumferential direction, as shown in FIG. 7A. This convection interferes with the turning of the first turbine side protrusion 54. Also, such convection becomes larger as the speed ratio Sr decreases. That is, only the pump impeller 45 rotating while the turbine runner 46 is stationary produces the largest convection. This is because the turbine blades 49 do not turn, and thus the first turbine side protrusions 54 thereof strongly interfere with the smooth circulation of the hydraulic oil. Therefore, the first turbine side protrusions 54, that is, the turbine blades 49, rotate less easily as the convection becomes larger. In other words, according to the present embodiment, even when the speed ratio Sr decreases, the capacity coefficient C does not increase to the extent of the conventional turbine blades, as shown in FIG. 8, because the distal ends of the first turbine side protrusions 54 point in the rotation direction R.

Moreover, when the rotation of the pump impeller 45 is transmitted to the turbine runner 46 via the hydraulic oil, the turbine blades 49 turn. Then, the hydraulic oil present in the space between two turbine blades 49 that are adjacent to each other in the circumferential direction flows from the first turbine side protrusion 54 side to the second turbine side protrusion 55 side, such that the hydraulic oil is pushed out from the second side surface 49b of the turbine blade 49 that is positioned on the upstream side in the rotation direction R. From the space between two second turbine side protrusions 55 that are adjacent to each other in the circumferential direction, the hydraulic oil is pushed out to the pump impeller 45 side due to the turning of the turbine blades 49.

The second turbine side protrusion 55 of the present embodiment is shaped by bending such that the distal end thereof points to a direction opposite the rotation direction R. Therefore, compared to the conventional fluid coupling in which the second turbine side protrusions 55 are not bent, the second turbine side protrusion 55 more suitably applies a pushing force in the lower left direction in FIGS. 6 and 7D to the hydraulic oil present on the second side surface 49b side of the second turbine side protrusion 55. As a result, the hydraulic oil pushed out by the second turbine side protrusion 55 smoothly flows toward the second pump side protrusion 52, which is positioned on the downstream side of the second turbine side protrusion 55 in the rotation direction R, as shown in FIG. 7D.

The hydraulic oil pushed out by the second turbine side protrusion 55 applies a pushing force in the rotation direction R to the second pump side protrusion 52 of the pump blade 47, which is positioned on the downstream side in the rotation direction R of the second turbine side protrusion 55 that pushed out the hydraulic oil. At the same time, the hydraulic oil flows into between two second pump side protrusions 52 that are adjacent to each other in the circumferential direction. The second pump side protrusion 52 of the present embodiment is shaped by bending such that the distal end thereof points in the rotation direction R. Therefore, compared to the conventional fluid coupling in which the second pump side protrusions 52 are not bent, the hydraulic oil pushed out by the second turbine side protrusion 55 more easily flows into the space between two second pump side protrusions 52 that are adjacent to each other in the circumferential direction. As a result, convection is not generated in the space between two second pump side protrusions 52 that are adjacent to each other in the circumferential direction, and therefore, the hydraulic oil smoothly circulates. Thus, the hydraulic oil flows inside the space between two pump blades 47 that are adjacent to each other in the circumferential direction toward the first pump side protrusion 51 due to the pushing force from the second side surface 47b of the turning pump blade 47.

Next, variation in the capacity coefficient C when the third bending angle θTin is changed will be described with reference to FIG. 9.

FIG. 9 shows variation in the capacity coefficient C when the third bending angle θTin is set to 42.5°, variation in the capacity coefficient C when the third bending angle is set to 50°, and variation in the capacity coefficient C when the third bending angle is set to 55°. As shown in FIG. 9, the amount of variation in the capacity coefficient C in accordance with the speed ratio Sr decreases as the third bending angle θTin increases. That is, the capacity coefficient C when the speed ratio Sr is 0 (meaning when the pump impeller 45 rotates while the turbine runner 46 is stationary, and also referred to as an idling state) decreases as the third bending angle θTin increases.

Therefore, in the present embodiment, the following effects can be obtained.

(1) The first turbine side protrusion 54 of each turbine blade 49 is formed such that the distal end thereof is positioned on the downstream side of the base end thereof in the rotation direction R. Therefore, when the pump impeller 45 rotates in the rotation direction R, convection interfering with the smooth flow of hydraulic oil is generated in the space between two first turbine side protrusions 54 that are adjacent to each other in the circumferential direction. Such convection hinders the turbine blades 49 from turning, leading to a reduction in the capacity coefficient C. Moreover, when the speed ratio Sr of the turbine runner 46 with respect to the pump impeller 45 decreases, convection generated between two first turbine side protrusions 54 that are adjacent to each other in the circumferential direction becomes larger, and therefore, the reduction in the capacity coefficient C becomes more remarkable. Furthermore, it is not necessary to provide a baffle plate, reservoir chamber, or the like in addition to the pump impeller 45 and the turbine runner 45, and thus, an increase in the sizes of the fluid coupling 19 and the starting device 11 can be suppressed. Therefore, it is possible to suppress increases in the size and variation of the capacity coefficient C in accordance with the speed ratio Sr.

(2) Each second turbine side protrusion 55 is formed such that the distal end thereof is positioned on the upstream side of the base end thereof in the rotation direction R. Therefore, the hydraulic oil can smoothly flow out from the space between two second turbine side protrusions 55 that are adjacent to each other in the circumferential direction to the second pump side protrusion 52 side. That is, the circulation efficiency of the hydraulic oil between the pump impeller 45 and the turbine runner 46 increases. Thus, the torque transmission efficiency from the pump impeller 45 to the turbine runner 46 increases overall in accordance with the increase in the circulation efficiency of the hydraulic oil between the pump impeller 45 and the turbine runner 46, regardless of the magnitude of the speed ratio Sr. As a result, the capacity coefficient C can be maintained generally large regardless of the magnitude of the speed ratio Sr.

(3) Each first pump side protrusion 51 is formed such that the distal end thereof is positioned on the downstream side of the base end thereof in the rotation direction R. Therefore, the hydraulic oil can smoothly flow out from the space between two first pump side protrusions 51 that are adjacent to each other in the circumferential direction to the first turbine side protrusion 54 side. That is, the circulation efficiency of the hydraulic oil between the pump impeller 45 and the turbine runner 46 increases. Thus, the torque transmission efficiency from the pump impeller 45 to the turbine runner 46 increases overall in accordance with the increase in the circulation efficiency of the hydraulic oil between the pump impeller 45 and the turbine runner 46, regardless of the speed ratio Sr. As a result, the capacity coefficient C can be maintained generally large regardless of the magnitude of the speed ratio Sr.

(4) Each second pump side protrusion 52 is formed such that the distal end thereof is positioned on the upstream side of the base end thereof in the rotation direction R. Therefore, the hydraulic oil smoothly flows into the space between two second pump side protrusions 52 that are adjacent to each other in the circumferential direction from the second turbine side protrusion 55 side. That is, the circulation efficiency of the hydraulic oil between the pump impeller 45 and the turbine runner 46 increases. Thus, the torque transmission efficiency from the pump impeller 45 to the turbine runner 46 increases overall in accordance with the increase in the circulation efficiency of the hydraulic oil between the pump impeller 45 and the turbine runner 46 regardless of the speed ratio Sr. As a result, the capacity coefficient C can be maintained generally large regardless of the magnitude of the speed ratio Sr.

(5) Variation in the capacity coefficient C in accordance with changes in the speed ratio Sr of the turbine runner 46 with respect to the pump impeller 45 is suppressed. Therefore, it is possible to suppress variation in the efficiency of torque transmission from the engine 12 side to the speed change mechanism side via the fluid coupling 19 based on a traveling state of the vehicle.

Note that the present embodiment may be modified as the following embodiments.

The pump impeller 45 may include a ring-shaped pump core that is supported by the pump cover 15 via the radial intermediate parts (parts between the protrusions 51, 52) of the pump blades 47, in order to increase the strength of the pump impeller 45.

The turbine runner 46 may include a ring-shaped turbine core that is supported by the turbine shell 48 via the radial intermediate parts (parts between the protrusions 54, 55) of the turbine blades 49, in order to increase the strength of the turbine runner 46.

The second turbine side protrusion 55 of each turbine blade 49 may have an unbent configuration, that is, a configuration in which the distal end and the base end are arranged in the same position in the rotation direction R. With this configuration, the capacity coefficient C overall becomes a small value while the variation in the capacity coefficient C in accordance with changes in the speed ratio Sr can be reduced compared to the conventional fluid coupling.

The first pump side protrusion 51 of each pump blade 47 may have an unbent configuration, that is, a configuration in which the distal end and the base end are arranged in the same position in the rotation direction R. With this configuration, the capacity coefficient C overall becomes a small value while the variation in the capacity coefficient C in accordance with changes in the speed ratio Sr can be reduced compared to the conventional fluid coupling.

The second pump side protrusion 52 of each pump blade 47 may have an unbent configuration, that is, a configuration in which the distal end and the base end are arranged in the same position in the rotation direction R. With this configuration, the capacity coefficient C overall becomes a small value while the variation in the capacity coefficient C in accordance with changes in the speed ratio Sr can be reduced compared to the conventional fluid coupling.

Any one of the pump blades 47 may have a configuration that does not include the first pump side protrusion 51 or the second pump side protrusion 52 on the inner side or outer side thereof in the radial direction.

Any one of the turbine blades 49 may have a configuration that does not include the first turbine side protrusion 54 or the second pump side protrusion 55 on the inner side or outer side thereof in the radial direction.

The blade main body 50 of each pump blade 47 may be bent such that, in the radial outer part of the pump blade 47, a portion on the outer side in the radial direction is positioned further downstream in the rotation direction R than a portion on the inner side in the radial direction.

The blade main body 50 of each pump blade 47 may be bent such that, in the radial inner part of the pump blade 47, a portion on the inner side in the radial direction is positioned further downstream in the rotation direction R than a portion on the outer side in the radial direction.

The blade main body 53 of each turbine blade 49 may be bent such that, in the radial outer part of the turbine blade 49, a portion on the outer side in the radial direction is positioned further downstream in the rotation direction R than a portion on the inner side in the radial direction.

The blade main body 53 of each turbine blade 49 may be bent such that, in the radial inner part of the turbine blade 49, a portion on the inner side in the radial direction is positioned further upstream in the rotation direction R than a portion on the outer side in the radial direction.

In the embodiments, the bending angles θPin, θPout, θTin, and θTout may be individually set at desired angles ranging from 0° to 90° (60°, for example).

In the embodiments, the starting device 11 may have a configuration that does not include the clutch mechanism 17.

In the embodiments, the fluid coupling may be embodied as a fluid coupling that is provided in apparatuses other than vehicles (in the power transmission path of a ship, for example).

What is claimed is:

1. A fluid coupling comprising:
a pump impeller that is disposed on a torque transmission path, rotatable about a predetermined rotation axis, and includes a plurality of pump blades arranged along a circumferential direction about the rotation axis; and
a turbine runner that is disposed on a downstream side of the pump impeller in the torque transmission path, and includes a plurality of turbine blades arranged along the circumferential direction about the rotation axis, wherein
when the pump impeller rotates in a predetermined rotation direction due to transmitted torque, a fluid circulates between the pump impeller and the turbine runner, such that the turbine runner rotates in the rotation direction about the rotation axis, and
the turbine blades each include, with respect to a radial direction about the rotation axis, an intermediate part, an outer part that is positioned farther outward than the intermediate part, and an inner part that is positioned farther inward than the intermediate part, and in at least one of the plurality of turbine blades, the outer part is formed so as to be positioned on the downstream side of the intermediate part in the rotation direction.

2. The fluid coupling according to claim 1, wherein in at least one of the plurality of turbine blades, the inner part is formed so as to be positioned on an upstream side of the intermediate part in the rotation direction.

3. The fluid coupling according to claim 2, wherein the pump blades each include an intermediate part and an outer part that is positioned farther outward than the intermediate part with respect to the radial direction about the rotation axis, and in at least one of the plurality of pump blades, the outer part is formed so as to be positioned on the downstream side of the intermediate part in the rotation direction.

4. The fluid coupling according to claim 3, wherein the pump blades each include an intermediate part and an inner part that is positioned farther inward than the intermediate part with respect to the radial direction about the rotation axis, and in at least one of the plurality of pump blades, the inner part is formed so as to be positioned on the downstream side of the intermediate part in the rotation direction.

5. A starting device for transmitting torque from a driving source to an input member of a speed change mechanism, comprising:
a housing to which the torque from the driving source is transmitted, and which is filled with a fluid; and
the fluid coupling according to claim 4, wherein
the fluid coupling is disposed in the housing, and
the pump impeller is fixed to the housing and the turbine runner is connected to the input member of the speed change mechanism.

6. The fluid coupling according to claim 1, wherein the pump blades each include an intermediate part and an outer part that is positioned farther outward than the intermediate part with respect to the radial direction about the rotation axis, and in at least one of the plurality of pump blades, the outer part is formed so as to be positioned on the downstream side of the intermediate part in the rotation direction.

7. The fluid coupling according to claim 1, wherein the pump blades each include an intermediate part and an inner part that is positioned farther inward than the intermediate part with respect to the radial direction about the rotation axis, and in at least one of the plurality of pump blades, the inner part is formed so as to be positioned on the downstream side of the intermediate part in the rotation direction.

8. A starting device for transmitting torque from a driving source to an input member of a speed change mechanism, comprising:
a housing to which the torque from the driving source is transmitted, and which is filled with a fluid; and
the fluid coupling according to claim 1, wherein
the fluid coupling is disposed in the housing, and
the pump impeller is fixed to the housing and the turbine runner is connected to the input member of the speed change mechanism.
